(19) United States
(12) Patent Application Publication
(10) Pub. No.: US 2011/0272048 A1
(43) Pub. Date: Nov. 10, 2011

(54) ARRANGEMENT OF PULSE-MODULATED QUICK-ACTING VALVES, TANK SYSTEM, METHOD FOR PREPARING A REQUIRED MASS FLOW AND USE OF A TANK SYSTEM

(75) Inventors: Ing. Stefan Glaeser, Bottighofen (CH); Werner Janisch, Owingen (DE)

(73) Assignee: Eugen Seitz AG, Wetzikon (CH)

(21) Appl. No.: 13/097,298

(22) Filed: Apr. 29, 2011

(30) Foreign Application Priority Data
May 6, 2010 (EP) 10405097.6

(51) Int. Cl. B65D 90/00; F16K 31/02; G05D 16/06

(52) U.S. Cl. 137/613; 251/129.01; 220/694

(57) ABSTRACT

The invention relates to an arrangement of pulse-modulated quick-acting valves on a fluid storage device, wherein the valves have different nominal widths for operation thereof in different pressure ranges with otherwise identical structure. The number of the valves and the respective nominal widths thereof is selected and matched to a fluctuation range of the pressure in the storage device such that over this fluctuation range of the storage device pressure, by complete opening, complete closing and/or switching individual valves or valve combinations, a total dispensed mass flow of the fluid from the storage device in a fluctuation range of varying mass flows of constant pressure as required can be produced.

The invention relates to an arrangement of pulse-modulated quick-acting valves on a fluid storage device according to patent claim 1, a tank system having a fluid storage device according to patent claim 4, a method for supplying a required mass flow according to patent claim 14 and a use of a tank system according to patent claim 16.

Fuel cells are known as a power source for units in the automobile sector. Fuel cells with a proton exchange membrane (proton exchange membrane PEM) are widely used here, wherein the anode of the fuel cell is supplied with hydrogen as fuel and the cathode is supplied with oxygen as oxidising agent. In this case, anode and cathode are separated by the proton exchange membrane through which the protons are exchanged but which is electronically non-conductive. Hydrogen and oxygen are converted into water through this electrochemical reaction. In this case, electrical energy is produced which is tapped by electrodes at respectively the anode and cathode. In a fuel cell system a plurality of fuel cells connected electrically in series are combined.

The hydrogen is stored here at high pressure in a fluid storage device which is accommodated in the vehicle in a position which is as protected as possible. With increasing design of the maximum pressure of the hydrogen-filled fluid storage device, the volume (and therefore the size) thereof can be reduced and/or the range of the vehicle operated with the fuel cell system can be increased. In the present-day fuel cell systems, the fluid storage device can be filled with hydrogen at a maximum pressure of 700 bar. The hydrogen enters into the fuel cell system via pipelines. The supply pressure in the fuel cell system is usually below 4 bar, wherein the mass flow lies in the range between 0.008 g/sec and 2,500 g/sec depending on the power. A pressure regulating valve is therefore interposed in the course of the pipelines between the fluid storage device and the fuel cell system, which reduces and consequently adapts the pressure of the hydrogen inside the fluid storage device to the supply pressure in the fuel cell system.

Conventional pressure-regulating valves which are designed to reduce the pressure from, for example, 700 bar to approximately 10.0 bar, contain a cylinder in which the hydrogen is introduced, as well as a piston and a valve body disposed inside the cylinder. If the pressure of the hydrogen on the downstream side of the cylinder is lower than a pre-determined pressure, the piston is displaced contrary to the direction of a restoring force in a valve opening direction, in which one end of the piston opens the opening of the valve body. If the pressure of the hydrogen on the downstream side of the cylinder is higher than the predetermined pressure, the piston is displaced in the direction of the restoring force into a valve closing position in which one end of the piston closes the opening of the valve body.

The pressure relationships in a space between the surface of the piston and the inlet of the valve body plays an essential role here. This pressure is dependent on the (smallest) diameter or the nominal width of the valve body. The smaller the nominal width, the larger the pressure difference between the pressure chamber and the outlet of the valve body. A spring element disposed inside the cylinder presses the piston into the valve opening position. From the cooperation between in particular the spring force of this spring element, the surfaces of the piston at the inlet and at the outlet and the nominal width, a displacement of the piston takes place into the valve closing position as soon as the pressure at the (low-pressure) outlet of the cylinder exceeds a predetermined (low) pressure, this displacement being directed contrary to the direction of the applied force of the spring element. Having arrived in the valve closing position, the pressure at the outlet of the cylinder is reduced to a pressure below the predetermined (low) pressure, whereupon the piston is displaced in the direction of the applied force of the spring element into the valve opening position. This displacement of the valve body is repeated reciprocally during the pressure reduction operation so that a predetermined low pressure with little fluctuation is established at the outlet of the pressure regulating valve.

Motor vehicles having a fuel cell system as a unit usually contain a plurality of tank containers as fluid storage devices, for example, four tank containers which are interconnected via pipelines. Here a filling line is connected to this via a first valve which is attached to a first tank container. From this first valve a first pipeline leads to a second valve of a second tank container. This second tank container is in turn connected via a second pipeline to a third tank container, etc. Consequently, a pressure equalisation between the hydrogen-filled tank containers is established overall via the respective pipelines between the tank containers. The pressure regulating valve described above is coupled to a terminating pipeline at the end of the system and is in fluid communication with the fuel cell.

A disadvantage of this arrangement is that all the pipelines as far as the inlet of the pressure regulating valve are at high pressure. As a result, there is a particularly high accident risk since the high-pressure pipelines are liable to leak with the result that an uncontrollable hydrogen stream could reach the external surroundings and could ignite. Another disadvantage is that the pipelines at high pressure are expensive, have a high weight, are very complex to manufacture and in addition must be connected via expensive sealing elements. A further disadvantage is that the pipelines must have a large diameter since pressure regulating valves which are designed to reduce pressure from a maximum of 700 bar to approximately 10.0 bar already contain a valve body having a nominal width of approximately 3 mm. Since this large diameter must never be fallen below in the further course for correct operation of the pressure regulating valve, the pipelines must also have a large diameter which results in increased pipeline walls. As a result, the costs of the pipelines are increased once again, especially as pipelines having pipeline walls dimensioned in such a manner are difficult to form and to lay.

A further disadvantage is that the pressure regulating valve which must be designed to reduce a pressure from a maximum of 700 bar to a pressure of approximately 10.0 bar has a large volume, therefore takes up a large amount of space and has a high weight. Known pressure regulating valves have a volume of approximately 7.0 cm×7.0 cm×18.6 cm and a high weight of approximately 2.5 kg.

A further disadvantage is that the pressure regulating valve can only supply a required outlet pressure or correct mass flow to the fuel cell system if a complete pressure equalisation is established between the individual tank containers. This pressure equalisation is in turn dependent on the smallest inside diameter of the pipelines connecting the individual tank containers. The larger this smallest inside diameter, the more rapidly a pressure equalisation takes place between the individual tank containers. However, the outside diameter of the individual pipelines also increases herewith, with the result that high costs are again incurred and a large amount of space is taken up.

A further disadvantage is that single-state pressure regulating valves are usually designed to regulate an inlet pressure as far as at least 10 bar. In order to be able to regulate pressure ranges below 10 bar, a second pressure regulating valve designed for this purpose is required. As a result, a large amount of space is taken again and high costs are produced.

In addition, a shut-off valve is usually required ahead of said pressure regulator, which is beset with the further disadvantage that it comprises a plurality of components which run into one another and have different coefficients of thermal expansion. For example, a sealing piston is made of plastic whereas a guide pipe is made of aluminium bronze. These components having materials having different coefficients of thermal expansion are connected directly to one another, are adjacent to one another or must run into one another. Shut-off valves are thereby subject to temperatures having a high fluctuation range. Due to the different coefficients of thermal expansion of, for example, adjacent components, different deformations of these components occur, with the result that functional disturbances as far as blockages of individual components among one another can occur. In this case, a complete functional failure of the pressure regulating valve can occur.

A further disadvantage is that the outlet pressure present at the outlet of the pressure regulating valve has a high fluctuation. Overall a reduction in the inlet pressure is also accompanied by a reduction in the outlet pressure. A further disadvantage is that the spring element of the pressure regulating valve must be designed according to requirements to apply a high force for pressing the valve body into the valve opening position. In conventional pressure regulating valves for reducing a hydrogen outlet pressure from a maximum of 700 bar to approximately 10.0 bar, spring elements which can be adjusted according to requirements are necessary, which can apply a force of up to approximately 1000 N. A spring element which meets these requirements is difficult to adjust, exhibits nonlinear properties in the adjustable range and has a high weight.

A further disadvantage consists in that the pressure regulating valve contains dynamic seals as required, each comprising sealing elements which move relative to one another. These dynamic seals are expensive, difficult and time-consuming to install and have a high probability of causing leakage losses. As a result of the permanent friction of the dynamic seals, they are subject to rapid wear. A further disadvantage consists in that the sealing element of the shut-off valve comprises a high-performance plastic. High form and surface requirements are therefore necessary to eliminate leakages. A further disadvantage is that a shut-off valve has a high number of components. These components comprise at least two spring elements, a sealing piston, a pilot needle, a connecting element, etc.

A further disadvantage consists in that the moving masses of the pressure regulating valve have a high weight. In particular, the valve body to be moved is therefore subjected to an increased wear. Furthermore, guides and sealing surfaces between the valve body and the cylinder are exposed to a high wear which results in an inaccurate guidance and a defective seal between valve body and cylinder. The weight of the masses to be moved of a conventional pressure regulating valve amount to, for example, 330 g. A further disadvantage consists in that the intermediate space of the pressure regulating valve must be open to the atmosphere. More precisely, a pressure equalisation is required between the space inside the cylinder for receiving the spring element and the atmosphere in order to avoid the disadvantageous effect of air cushioning.

A further disadvantage of the arrangement consists in that a large number of line intersections is required. In the case of a fluid storage device which is composed, for example, of four tank containers, 13 line intersections are required. However, with increasing number of line intersections, the probability of an occurrence of leaks increases. A further disadvantage is that the pressure regulating valve of the structure described previously is normally open since the spring element presses the valve piston into the valve open position. This permanently open position of the pressure regulating valve increases the probability of damage due to pressure peaks such as are produced when switching the shut-off valve. In addition, the risk of pressure losses increases.

EP 1 264 976 A1 discloses a control system for a fuel engine of a vehicle comprising a pressurised fluid storage device, a line connected to the fluid storage device and a switching valve which is disposed in the course of the line to regulate the supply of fluid from the fluid storage device to the fuel engine. The switching valve is formed by an electromagnetic valve which can control the pressure of the fluid to be supplied to the fuel engine depending on the mass flow present there. The electromagnetic valve is controlled by commands from a control unit (ECU) in open/closed states. The electromagnetic valve in this case has a variable degree of opening which is proportional to an applied voltage. This voltage is in turn output by the ECU as a function of operating parameters of the fuel engine. It is a disadvantage that this switching valve operates inaccurately since the mass flow can merely be regulated via the small adjustment path of the valve needle in relation to the valve seat.

Pulse-modulated quick-acting valves are known for more precise passage of the mass flow. Due to different frequencies or different opening times (at the same frequency “pulse width modulation”), a different amount of fluid is guided through the quick-acting valve. A different outlet pressure and/or mass flow can be adjusted by this means. Similarly to the pressure regulating valve described previously, the pressure reduction approach is also adopted here. A decompression chamber and a pressure adjusting chamber are defined here and the movable piston contains a pressure receiving surface exposed to the decompression chamber and a pressure adjusting surface exposed to the pressure adjusting chamber. If the force applied to the pressure receiving surface consequently becomes greater than the force applied to the pressure adjusting surface, the piston moves in the direction of the pressure adjusting chamber. This has the effect that the valve body of the piston closes the valve seat, whereby the flow of a fluid from the valve chamber to the decompression chamber is interrupted. If, on the other hand, the force applied to the pressure receiving surface is lower than the force applied to the pressure adjusting surface, the piston moves in the direction of the decompression chamber. This has the effect that the valve seat is opened. Consequently, the difference between these two forces can be adjusted by a suitable choice of the pressure receiving surface and the pressure adjusting surface or their relationship to one another.

Furthermore, a further adjustment parameter is given by the nominal width of a yoke part. The quick-acting valve can optionally contain the previously described spring element for retracting the piston. It also contains an electromagnetic valve arrangement which consists of an electromagnet and an armature. The armature is in this case configured as the piston. The electromagnet is arranged axially around the armature. When the electromagnet is energised, the armature is pressed by an induced electromagnetic field and a magnetic force caused thereby from the open position to the closed position or conversely.

From the interaction between the purely mechanical arrangement (pressure difference in relation to the armature surfaces, suitable choice of nominal width of the yoke part, optional spring force etc.) and the electrical arrangement (controllably forced reciprocal movement of the armature), there is created a quick-acting valve which on its outlet side provides a desired fluid pressure and/or mass flow with a small fluctuation width.

A problem is that such a quick-acting valve from the prior art can only be used for pressure reduction within a predetermined pressure range. For example, quick-acting valves for handling from a maximum inlet pressure are provided with a yoke part having a minimal nominal width which reduce this maximum inlet pressure to a desired low pressure. The parameter “nominal width” and the further parameters of the quick-acting valve are determined in such a manner that the force is sufficient for moving the armature in the valve closing direction within a predetermined range during operation. This is necessary so that the components for configuring the electromagnetic valve arrangement, that is the armature and the electromagnet, are dimensioned and determined in such a manner that specifications regarding the overall size of the quick-acting valve are not infringed.

In other words: with decreasing high pressure which falls below a lower threshold value, the force required to move the armature into the valve closing position can only be achieved by the electromagnet and the armature having those configurations or dimensions in regard to overall size, number of copper windings, diameter of copper wire (in the electromagnet) etc. which no longer meet the requirements regarding the dimensions and the weight of the quick-acting valve. Consequently, whilst adhering to the specifications in regard to the dimensions and the weight of the quick-acting valve, a high pressure whose magnitude falls below the lower threshold value can no longer be regulated or reduced. By implication, a quick-acting valve which can handle a high pressure in the range of almost all pressure ranges would be disproportionately large and heavy. By providing the electromagnetic valve arrangement with increased capacity, the number of copper windings of the electromagnet must be increased, with the result that the weight is increased and additional costs incurred.

Particularly in automobile manufacture with increasing specifications with regard to spatial economy and weight saving, a conventional quick-acting valve rapidly reaches its limits regarding its use for pressure reduction of a high pressure which goes below a lower threshold value. Consequently, a fluid in a fluid storage device whose pressure has fallen below the threshold could no longer be handled. When considered for application in the automobile sector, a certain amount of fluid would remain unused in the fluid storage device which, among other things, has major disadvantages with regard to the range of the vehicle.

It is the object of the present invention to provide an arrangement of pulse-modulated quick-acting valves on a fluid storage device, a tank system with a fluid storage device, a method for supplying a required mass flow and a use of a tank system wherein a constant outlet pressure is supplied even with a highly variable inlet pressure and a highly variable mass flow.

The object is achieved by an arrangement of pulse-modulated quick-acting valves on a fluid storage device according to patent claim 1. The particular feature of this arrangement of pulse-modulated quick-acting valves is that those quick-acting valves are switched or operated which are necessary for the required mass flow and the outlet pressure present in each case. Also merely a single quick-acting valve can be switched or operated.

At a high outlet pressure and if a maximum outlet pressure and/or maximum mass flow is required, for example, only that pulse-modulated quick-acting valve will be switched which has the smallest nominal width compared with the other quick-acting valves. Consequently, the electrical power required for switching the quick-acting valve is very small compared to operation of the further quick-acting valves. By implication an electromagnet having a low power is sufficient. This has advantageous effects for reduction of the size of the electromagnet and consequently also for reduction of the overall size of the quick-acting valve. At a lower inlet pressure a quick-acting valve having a larger nominal width is switched for the provision of a maximum outlet pressure and/or maximum mass flow. In the case of this quick-acting valve, a low electrical power is also required for switching so that in turn an electromagnet having a low power is required. The electromagnet and consequently the quick-acting valve therefore have a small overall size.

In summary, all the quick-acting valves can be constructed with the same overall size and design. A single quick-acting valve or a plurality of quick-acting valves from the arrangement therefore operate, exactly matched to one another, against the inlet pressure applied in each case taking into account the outlet pressure and/or mass flow to be provided. Taking into account these parameters, then only those quick-acting valves are operated which are optimally matched thereto at this time. Consequently the quick-acting valves are designed in such a manner that they only switch in the presence of the matched ranges for them (inlet pressure and outlet pressure and/or mass flow to be supplied).

A quick-acting valve particularly suitable for use in the arrangement according to the invention comprises a respective pressure pipe having an armature made of a magnetically conductive material mounted so that it can be moved therein towards a nozzle component, wherein the pressure pipe is surrounded by a cylindrical electromagnet, whose axial ends extend beyond a movement range of the armature in the pipe and are connected in a magnetically conductive manner to a core and a yoke part of the respective valve, which fix the movement range of the armature in the pressure pipe and the armature embraces the yoke part at least partially. As a result, a magnetic flux is generated which, on the one hand, is amplified appreciably by the magnetically conductive parts located in the pressure pipe. Since the armature embraces the yoke part at least partially, it is ensured to be almost interruption-free. Overall, an opening of the valve over a particularly wide pressure range is possible as far as very high pressures occur, for example, in tank systems for fuel gases.

The fluid storage device is preferably configured as a single tank container which has a valve head comprising a group of quick-acting valves. As a result of this arrangement of the group of quick-acting valves in the valve head of the single tank container, the entire outlet line from the tank container to the fuel cell is acted upon by the very low outlet pressure. Consequently, this outlet line can comprise a far smaller outside diameter and a smaller material thickness. Furthermore, this outlet line can be less expensively sealed compared to a high-pressure line whereby weight and costs are saved.

The fluid storage device preferably consists of a plurality of interconnected tank containers whereas each have a respective valve head comprising a single quick-acting valve. This solution is very advantageous particularly in a vehicle which is operated with a fuel cell. In these vehicles the fluid storage device is formed from a plurality of mostly cylindrical tank containers which are accommodated, e.g. arranged horizontally adjacent to one another, in a defined space inside the motor vehicle. As a result of the respectively cylindrical configuration of a single tank container, this can be acted upon with a maximum pressure in relation to the material usage. In addition, the forces acting from outside, caused for example by a vehicle collision, are led away most effectively. Consequently this arrangement allows maximum protection against a leak or bursting under the impact of external forces, for example, caused by a collision.

With a horizontal arrangement of the individual tank containers in one plane, a spatial volume as small as possible is additionally used with maximum safety. In this arrangement of tank containers known in the prior art, the respective valve heads are equipped with merely one quick-acting valve. In this case, each of the quick-acting valves has a yoke part nozzle having different nominal width. For example, the fluid storage device is composed of four interconnected tank containers, wherein the valve heads of these tank containers each contain a single quick-acting valve having a yoke part nozzle having respectively graded nominal widths between approximately 0.2 and 2.5 mm.

At a maximum inlet pressure of up to 900 bar, such as prevails for example in freshly refuelled tank containers, then, depending on the required mass flow and/or outlet pressure, for example, only the quick-acting valve having a yoke part nozzle having the smallest nominal width is switched for valve opening. At an inlet pressure of 250 to 15 bar, the quick-acting valve having a yoke part nozzle having the second smallest nominal width can be switched for valve opening. At an inlet pressure of 130 to 15 bar, furthermore the quick-acting valve having a yoke part nozzle having the third smallest nominal width can be switched for valve opening. At an even lower inlet pressure the quick-acting valve having a yoke part nozzle having the fourth smallest nominal width can be switched for valve opening. The previously described example serves merely for the fundamental explanation of the arrangement, wherein the smallest, second smallest, third smallest and fourth smallest nominal width should be understood such that these become increasingly larger starting from the smallest nominal width. Naturally, two, three or all four quick-acting valves can additionally be switched for valve opening. In the case of n=4 tank containers, a switching matrix of 2n−1=15 valve switching states is obtained in a binary manner (the two states are defined by valve closing position/valve open position). These extend from the switching of the individual quick-acting valve having a yoke part nozzle having the smallest nominal width at maximum inlet pressure for delivering a maximum outlet pressure and/or mass flow as far as the switching of all four quick-acting valves at minimal inlet pressure or almost emptied tank containers.

The arrangement therefore provides an efficient switching of the quick-acting valves at a low power to be applied to the respective electromagnets as far as possible. This applies at the same time taking into account the inlet parameter “inlet pressure” and the outlet parameter “required outlet pressure and/or mass flow.” To this end 15 switching states of the respective quick-acting valves are provided. As a result of this high number of switching states, all the parameters are effectively covered accompanied by the minimal provision of power to the respective electromagnets. As described previously, the tank containers are interconnected via lines. This connection is provided by means of a pipeline system in such a manner that all the tank containers are acted upon with an identical pressure by means of pressure equalisation. Compared with the previously described arrangement containing a single tank container which has one valve head comprising a group of quick-acting valves, the last-mentioned arrangement has the disadvantage however that connecting lines between the tank containers which are acted upon with high pressure are switched.

The aforesaid object is also achieved by a tank container according to patent claim 4.

The quick-acting valves preferably comprise a respective pressure pipe having an armature made of a magnetically conductive material mounted so that it can be moved therein towards a nozzle component, wherein the pressure pipe is surrounded by a cylindrical electromagnet, whose axial ends extend beyond a movement range of the armature in the pipe and are connected in a magnetically conductive manner to a core and a yoke part of the respective valve, which fix the movement range of the armature in the pressure pipe and the armature embraces the yoke part at least partially. As a result, a magnetic flux is generated which is amplified appreciably by the magnetically conductive parts located in the pressure pipe. Since the armature embraces the yoke part at least partially, the path of the magnetic flux is almost free from interruption.

The fluid storage device is preferably configured as a single tank container having a valve head connected thereto, which comprises a group of quick-acting valves. In this so-called “one tank solution” there is the advantage that all the parts moving with respect to one another have a similar or even the same coefficient of thermal expansion. Consequently, in particular those components which run into one another have an identical thermal expansion at different temperatures. By this means material displacement is largely avoided even in case of high temperature fluctuations. As a result, the operating reliability of a respective quick-acting valve, in particular the sealing property, is substantially increased. A further advantage is that the maximum nominal width of the yoke part nozzle can be very much smaller compared with the prior art. As a result, the pressure pipe wall can be made very small. In addition, magnetic losses are very small. Additionally a low-pressure regulating unit is no longer required since the tank system alone is reduced to an outlet pressure as far as approximately 2.0 bar. Costs are hereby saved. In addition, the high weight of the low-pressure regulating unit is saved.

A further advantage is that when starting, for example, a motor vehicle operated with a fuel cell, no waiting time is required. A quite essential advantage is that the outlet pressure is regulated as a function of the required mass flow by the intelligent pressure regulation independently of the inlet pressure. In so doing, all the operating parameters are covered so that the required outlet pressure is always supplied reliably regardless of whether the tank container is filled to the maximum or almost emptied.

A very important advantage consists in that all the lines outside the tank container are merely acted upon by low pressure. As described previously, the laying of a high-pressure pipeline can thus be dispensed with, saving time, costs and weight. In addition, a very important advantage is that in the case of damage to these lines, for example, caused by an external action of force, no hydrogen can escape with a maximum pressure up to, for example, 700 bar. As a result, a risk from explosion or from suddenly expanding fluid is reduced very substantially.

A further advantage is that standard springs can be used inside the quick-acting valves, which need to apply a force of less than 10 N. These standard springs have a substantially linear force-distance profile, a low weight, a small overall size and in addition are available cheaply. Another advantage is that conventional quick-acting valves can be used whose development is already advanced. The development time and associated costs are hereby reduced. A conventional design of a pneumatic valve comprising an armature in interplay with a seal can be used here. In addition, the sealing elements of the valves can be made of favourable and universally applicable elastomers or plastics.

As described previously, the power of the electromagnetic valve arrangement is fundamentally determined by those parameters such as, for example, number of copper windings, diameter of copper wire, length of copper winding, as well as size and material of the armature. As has also been described previously, the switching matrix is defined for the respective switching or operating of the quick-acting valves as a function of the inlet and outlet parameters in such a manner that a power as low as possible is applied to the respective electromagnets. In other words, the electromagnetic valve arrangement, consisting of the electromagnet and the armature, needs to apply as little power as possible to displace the armature. Consequently, the parameters such as, for example, overall size and material of the armature, can be selected in such a manner that the armature has the lowest possible weight. For example, each armature per quick-acting valve has a weight of only 4 g.

Along with the advantage of the weight saving, a high switching frequency can further be achieved. A further advantage is that the system is completely sealed off from the atmosphere. Accident risks are hereby reduced. In addition, a particular advantage compared with the prior art is that the quick-acting valve remains closed in the absence of energising. Consequently, the occurrence of leaks inside the line system is greatly reduced, with the result that the accident risk is also reduced.

An advantage of the one-tank solution is further that only two line intersections are required. Consequently the assembly time for laying and connecting lines is reduced. Furthermore, weight and costs are reduced. In addition, there is also the advantage here that the probability of the occurrence of leaks can be reduced. A further advantage is that the tank container has a larger total opening cross-section compared with the prior art. As a result the tank container can be almost completely emptied with the result that the intervals for refilling are lengthened which in turn leads to a greater range of the motor vehicle.

Another essential advantage is that even in the event of an unintentional energising or a component failure, no uncontrollably large mass flow is possible. As described previously, the quick-acting valves are always closed in the absence of energising and the power input to the electromagnetic valve structure is limited in such a manner that the electromagnetic force is sufficient, for example, at an inlet pressure of 700 bar to merely open the quick-acting valve with the smallest nominal width. In this case, the operation of each quick-acting valve is independent of the outlet pressure. Consequently, the design at the same time has the advantage of a mass flow limitation even in the event of unintentional energising or a component failure.

An essential advantage of the tank system consists in its high flexibility in the case of changes regarding the framework conditions or parameters. If the framework conditions change, for example, such that a higher inlet pressure must be transferred or reduced to a low outlet pressure, merely one yoke part nozzle used needs to be exchanged for a yoke part nozzle having a smaller nominal width. Alternatively or additionally the group of quick-acting valves can be extended by one additional quick-acting valve. Consequently, a high flexibility is ensured which brings with it reduction of time and costs. Compared with the design from the prior art, there is also an advantage that the one tank solution has all the high-pressure components and high-pressure intersections inside the OTV (one tank valve). The risk of an explosion or rapid pressure expansion is reduced very substantially by this means. By implication, pipes and intersections can be laid or wired more rapidly.

The fluid storage device preferably consists of a plurality of interconnected tank containers having a valve head connected thereto in each case, which comprises a single quick-acting valve. Compared with the one tank solution, this so-called “multi-tank solution” has the advantage of a more two-dimensional arrangement inside a motor vehicle, e.g. in the horizontal. The design is additionally flexible and can be adapted with little effort to varying framework conditions in regard to the space available. Compared with the one tank solution, however more than two line intersections are necessary in this case. In the case of n tank containers (n−1)*4+2 line intersections are necessary. In the case of an arrangement of four tank containers, 14 line intersections are therefore required. Another difference compared with the one tank solution consists in that the entire refuelling line via which the pressure equalisation takes place within the plurality of tank containers in addition to the refuelling, is connected to the refuelling at a high pressure.

A low-pressure side of the at least one valve head is connected to a compensating container to absorb pressure waves. By this means the pressure waves produced by the rapid pressure differences are reliably absorbed. The compensating container is otherwise hermetically sealed and can, for example contain a volume of 5 litres.

Preferably the at least one valve head comprises a temperature sensor for measuring the temperature of the fluid in the tank container. Consequently the parameter “temperature” can be taken into account as an additional parameter when selecting and switching a respective quick-acting valve.

Preferably the high-pressure side of the at least one valve head can be connected to at least one refuelling line. In the multi tank solution the refuelling line runs over the respective high-pressure side of the valve heads, wherein respective branches are in fluid communication with the respective interior of the tank container. Consequently, no branch needs to be provided to the individual tank containers, saving costs, weight and time. As a result of the parallel connection of the individual tank containers to one another, the refuelling line is additionally used as pressure equalisation for producing a common equalising pressure over all the tank containers.

The quick-acting valves preferably have a nozzle component having respectively different nominal width. In this case, all the quick-acting valves have a nozzle component seat for receiving one of identically configured and shaped nozzle components having respectively different nominal widths. Consequently, the pressure range to be processed by each quick-acting valve can be very simply defined by the corresponding choice of the nominal width of a nozzle component. All the quick-acting valves therefore have the same structure and can thus be manufactured particularly inexpensively.

The nominal width of the individual quick-acting valves preferably lies in a range of approximately 0.2 mm to 2.5 mm. Consequently the inlet pressure in a range of, for example, 900 bar to 10 bar, divided into regions of individual or several quick-acting valves, can be precisely switched to a required mass flow and/or outlet pressure. This additionally applies at low power consumption and resulting low component size of the quick-acting valves.

The fluctuation range of the storage device pressure preferably lies between 10 bar and 900 bar and the fluctuation range of the required mass flow lies between 0.005 g/sec and 2,500 g/sec at a constant output pressure of less than 4 bar. Depending on the power to be produced by the fuel cell, the required mass flow fluctuates by the factor 400 and the storage device pressure fluctuates by the factor 80. Despite these high fluctuations, the tank system can provide a constant outlet pressure of less than 4.0 bar.

The aforesaid object is also achieved by a method for supplying a required mass flow of a fluid at constant pressure according to patent claim 14. In this case, only those quick-acting valves having different nominal width are opened, closed and/or switched which, depending on the determined current pressure in the fluid storage device, are necessary for the required mass flow and/or outlet pressure. As a result, for the first time it is possible that the respective electrical power consumption required to switch the electromagnetic valve arrangement inside each quick-acting valve can be low. This results in a substantial reduction in the component side of the electromagnetic valve arrangement and therefore overall in a reduction of the component size of the respective quick-acting valves.

A further advantage is that the armature of the electromagnetic valve arrangement has a lower weight compared to the solution from the prior art, whereby the reciprocal frequency of the movement of the armature can be increased, which in turn allows a faster switching of the quick-acting valves.

In a particularly advantageous embodiment of the method, in the event of an incorrect energisation of at least one of the quick-acting valves, a predetermined selection of valves dependent on the determined pressure is opened so that a mass flow actually delivered lies below the incorrectly required mass flow. A safety function against explosion or rapid pressure expansion of the fluid in the storage device is therefore provided. An incorrect energisation should exist if all the valves switched to currentless are suddenly energised without a corresponding mass flow actually being required. If, for example, an incorrect energisation of the valves occurs in such a manner that all the valves are to be opened without an actual requirement of a corresponding mass flow, it can be provided at a current pressure of 700 bar detected in the pressure storage device, only the valve having the smallest nominal width is energised. At a lower detected pressure of 400 bar, on the other hand, it can be provided that the valves having the smallest and second smallest nominal width are energised. Depending on the detected pressure, a different desired valve selection can naturally also be made. It is important that an undesired rapid pressure expansion or explosion is avoided by this selection.

The aforesaid object is also achieved by a use of a tank system according to one of claims 4 to 13 for supplying a fuel gas, in particular hydrogen, to a fuel cell, in particular to a fuel cell in a vehicle. Due to this use, vehicles having a fuel cell are provided which, regardless of respective driving properties and power requirements, receive a mass flow required here between 0.005 g/sec and 2,5000 g/sec at a reliably constant outlet pressure of less than 4.0 bar. This additionally applies in the case of a high fluctuation range of the storage device pressure between 900 bar and 10 bar. The vehicle is hereby provided with a reliable driving source which overall leads to improved driving properties. The use of this tank system further allows a weight reduction compared with the tank systems used from the prior art. The driving properties of the vehicle are hereby improved and/or the range of the vehicle is increased.

The present invention is explained in detail hereinafter by means of two embodiments with reference to the appended figures. Parts which are the same or which have the same effect are characterised by the same reference numerals. In the figures:

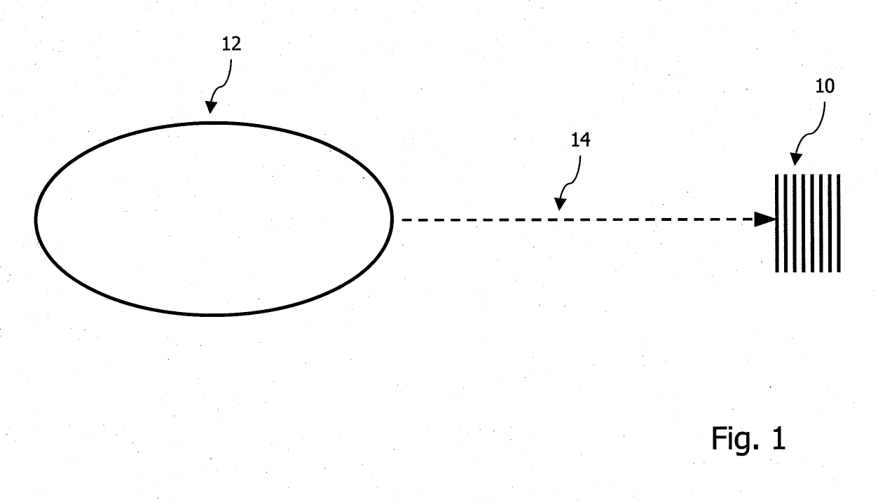

FIG. 1 shows a schematic diagram to illustrate the basic principle of supplying a fuel cell with a required mass flow;

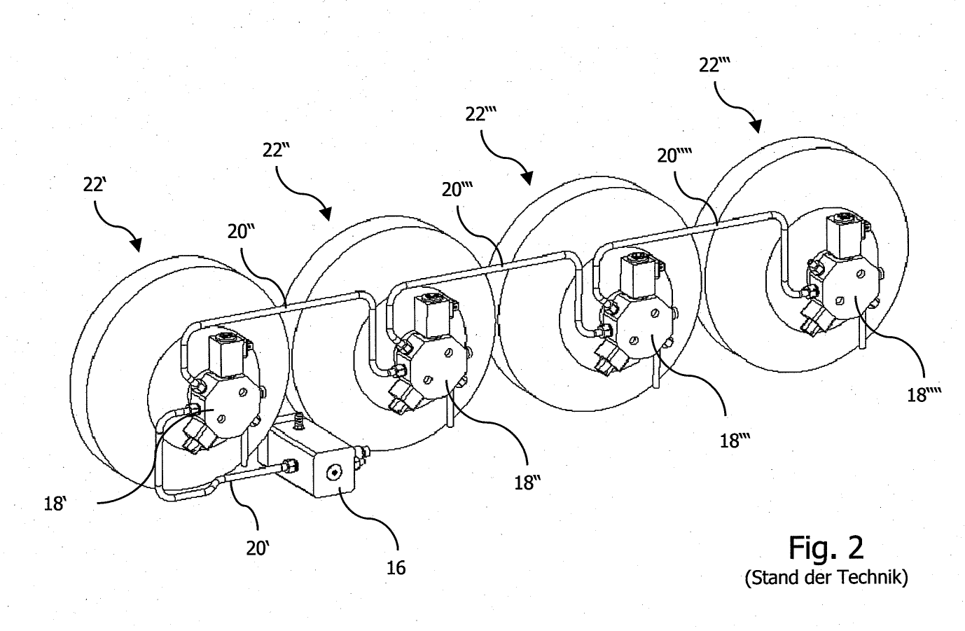

FIG. 2 shows a perspective view of an arrangement of valves on a plurality of tank containers having a downstream pressure regulator according to the prior art;

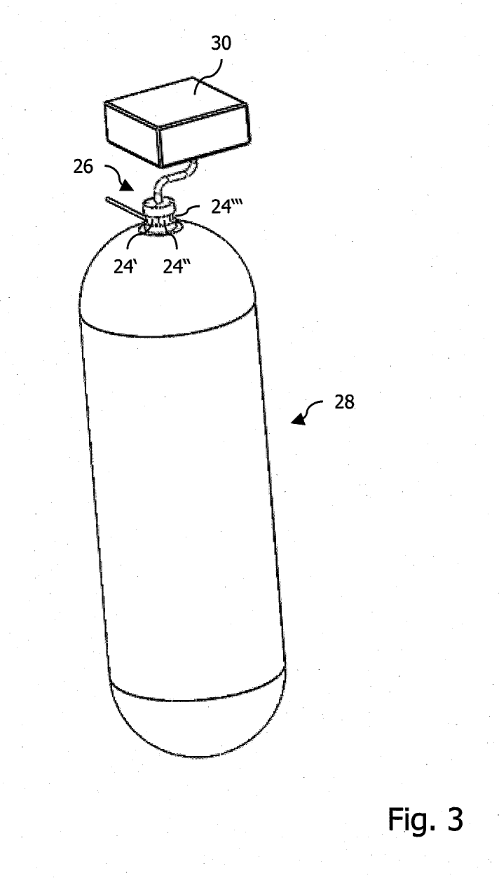

FIG. 3 shows a perspective view of an arrangement of pulse-modulated quick-acting valves in a valve head of a fluid storage device which is configured as a single tank container, according to a first embodiment of the present invention;

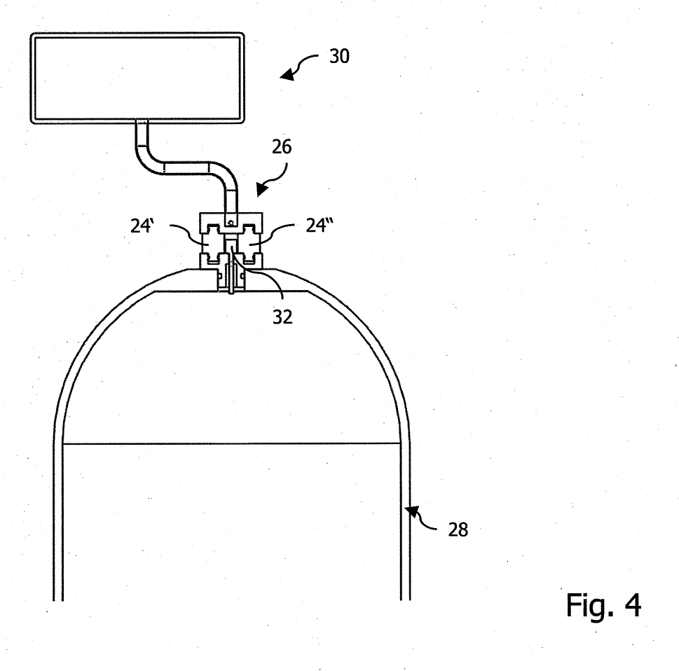

FIG. 4 shows a perspective sectional view of the arrangement shown in FIG. 3;

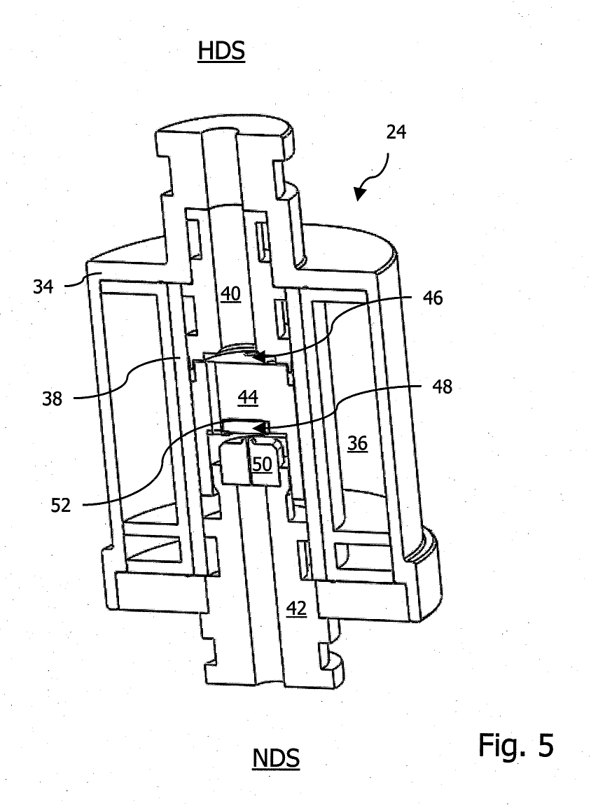

FIG. 5 shows a perspective sectional view of a pulse-modulated quick-acting valve;

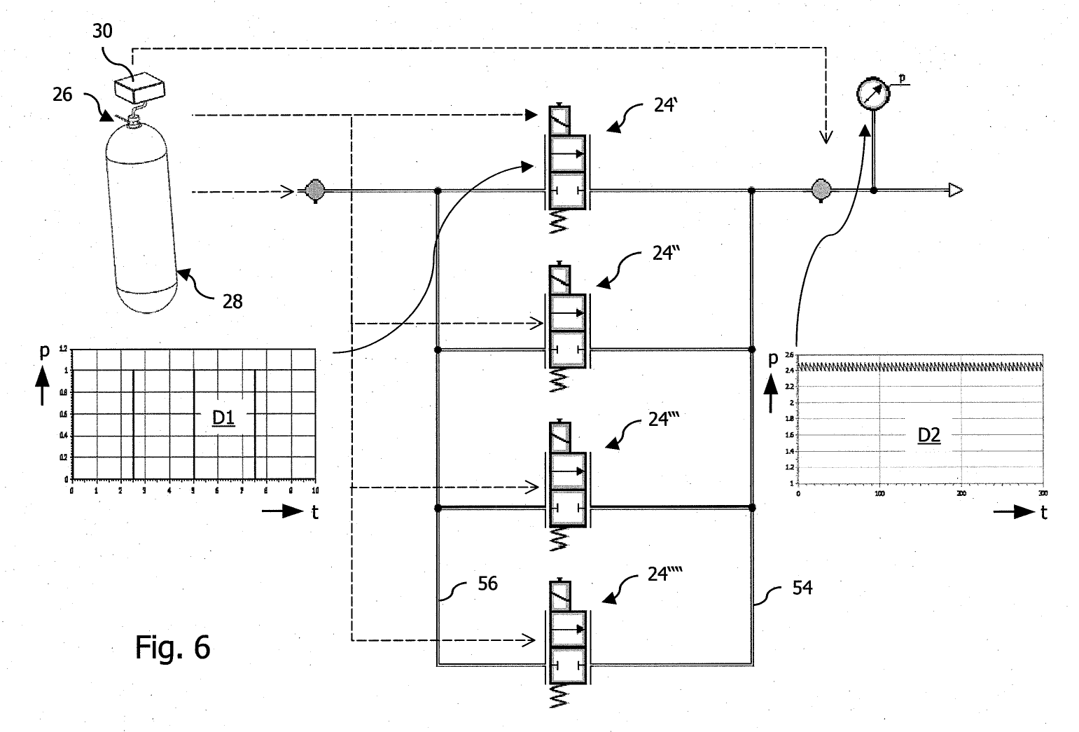

FIG. 6 shows a functional diagram of the arrangement shown in FIG. 3 with a diagram showing the switching intervals in relation to time and a diagram showing the outlet pressure in relation to time;

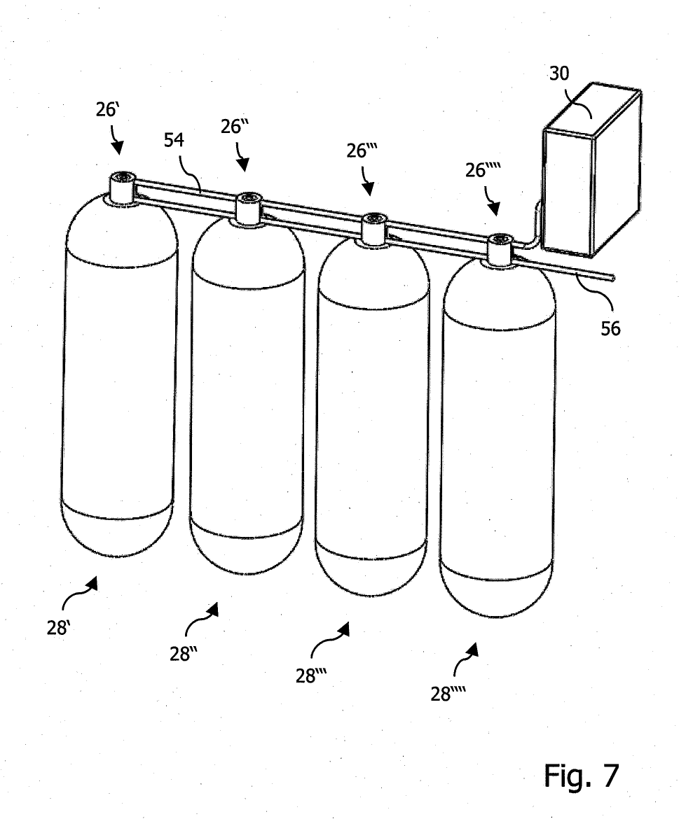

FIG. 7 shows a perspective view of an arrangement of pulse-modulated quick-acting valves in valve heads of a fluid storage device consisting of a plurality of interconnected tank containers according to a second embodiment of the present invention;

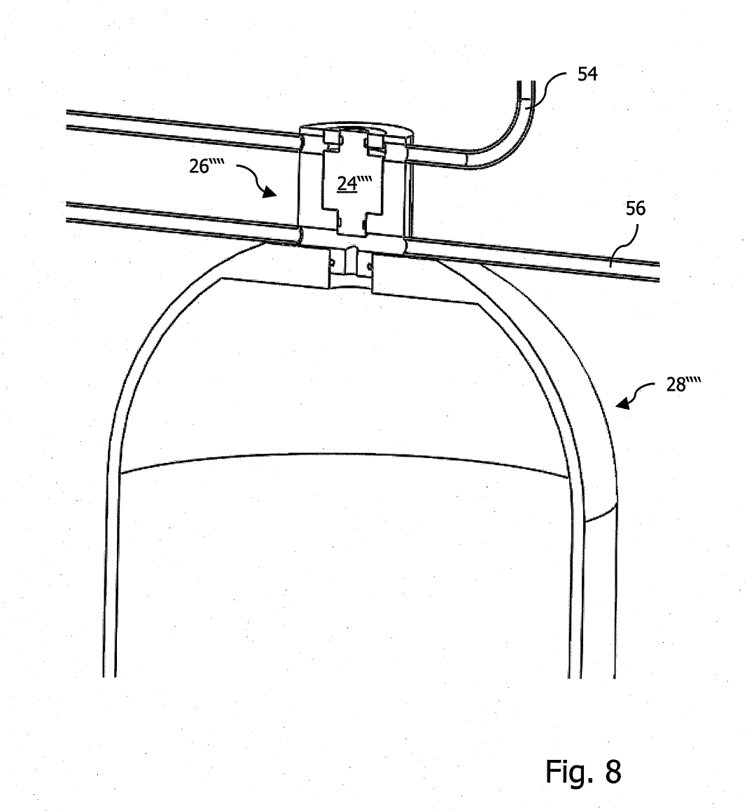

FIG. 8 shows a perspective sectional view of one of the tank containers shown in FIG. 7, its valve head, its refuelling and low-pressure line.

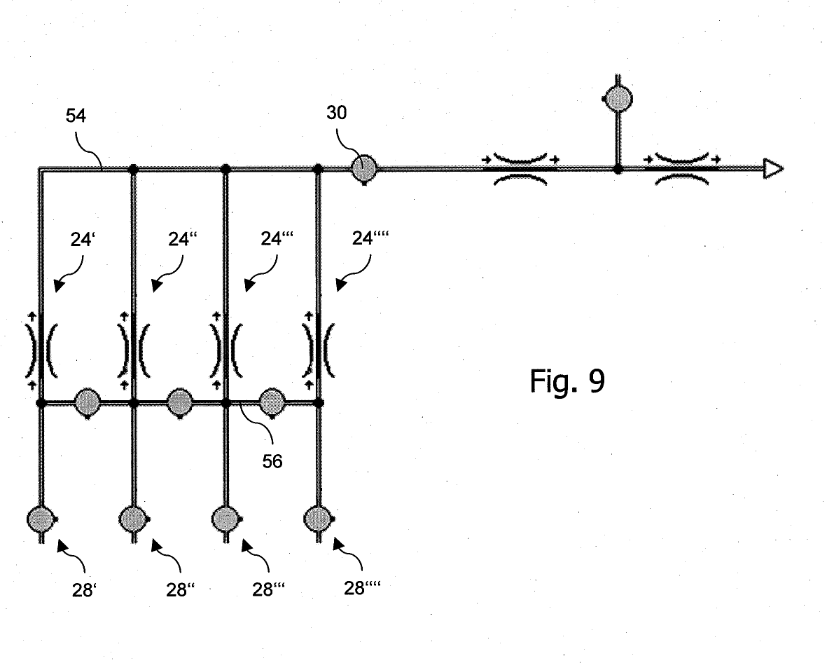

FIG. 9 shows a functional diagram of the arrangement shown in FIG. 7 and

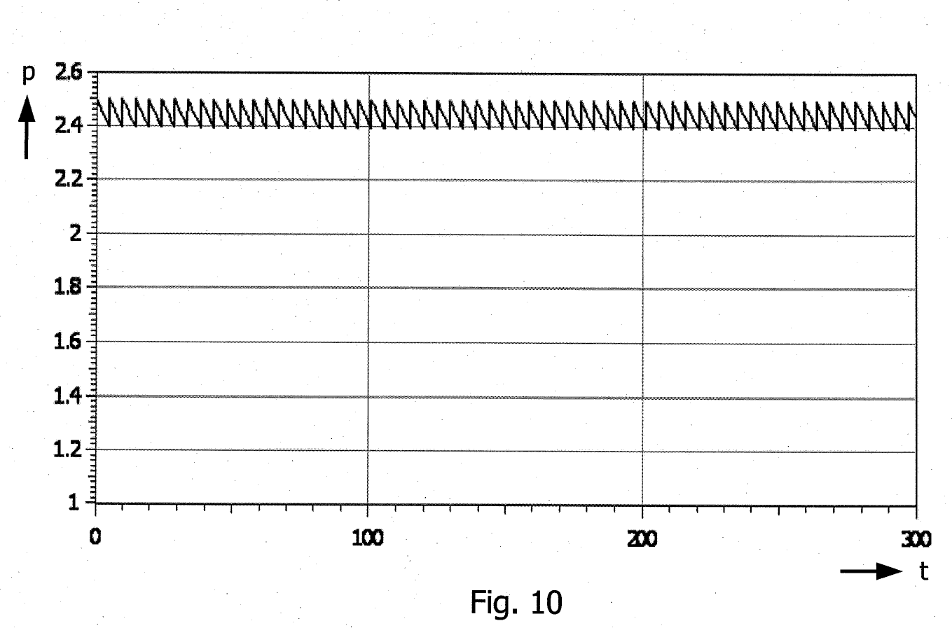

FIG. 10 shows a diagram of a curve profile of the outlet pressure in relation to time.

FIG. 1 shows a schematic diagram to illustrate the basic principle of supplying a fuel cell 10 with a required mass flow. In this example the fuel cell 10 of a vehicle (not shown) is supplied with hydrogen. In this principle, inter alia, two variable parameters should be noted, i.e. the inlet pressure of the hydrogen in this fluid storage device 12 which is dependent on the degree of filling of a fluid storage device 12 and the variable parameter of the mass flow required via a supply line 14 to the fuel cell 10. The outlet pressure applied at the outlet of the supply line 14 should be seen as the only constant in this interaction. This outlet pressure can, for example, be a constant 2.0 bar whereas the mass flow depending on the requirement lies in a range between 0.008 g/sec and 2.500 g/sec. In this case, for example, the lowest mass flow is only required when the vehicle is idling whereas the maximum mass flow is required at the peak performance of the vehicle.

As mentioned initially, the inlet pressure to be reduced plays an important role as a parameter. This inlet pressure is approximately 700 bar in the case of a fluid storage device filled to maximum capacity with hydrogen and decreases to a few bar in the case of an almost emptied fluid storage device 12. It is a challenge to regulate these two highly varying inlet parameters in such a manner that at the outlet of the supply line 14 and the inlet of the fuel cell 10, a constant outlet pressure of less than 4.0 bar is present at a respectively required mass flow.

FIG. 2 shows a perspective view of an arrangement of valves on a plurality of tank containers 22′ to 22″″ having a downstream pressure regulator according to the prior art. Attached to each tank container 22′ to 22″″ is respectively one valve head 18′ to 18″″ which in turn are interconnected by means of branch lines 20′ to 20″″. Consequently the individual tank containers 22′ to 22″″ are in fluid communication with one another so that a pressure equalisation is established. The valve head 18′ is connected to a pressure regulator 16 via the branch line 20′. At its outlet this provides a fluid, in this case hydrogen, having a low pressure of less than 4.0 bar, for example, 2.0 bar, to a fuel cell (not shown here).

This arrangement from the prior art has a plurality of disadvantages. Since the branch lines 20′ to 20″″ are at high pressure, in the case of a burst, for example, caused by an accident, a large amount of hydrogen is released in a very short time with the result that there is the risk of ignition and therefore explosion. The required sealing requirements can only be implemented, for example, by means of a high quality of the valve heads 18′ to 18″″ and an expensive high-performance plastic. Another disadvantage is that the mass flows delivered by the pressure regulator 16 are greater than specified if there is no counter-pressure on the outlet side.

Furthermore, the pressure regulator 16 has a very high weight of, for example, 2.5 kg and large dimensions of, for example, 18.6 cm×7.0 cm×7.0 cm. These two requirements run contrary to efforts in the automobile sector to reduce weight and save space. The pressure regulator 16 contains movable valve elements having a high weight of, for example, 330 g. As a result, the wear of the valve elements is increased. Furthermore, in the unoperated state the valve elements are permanently in a valve open position which brings with it further accident risks. Since in this area of application single-stage pressure regulators can merely regulate a fluid pressure as far as a minimum of about 15 bar, downstream pressure regulators are frequently necessary, whereby further costs are incurred and the weight is increased.

A quite substantial further disadvantage is that the pressure regulator 16—as has already been described hereinbefore—requires an upstream shut-off valve which is constructed of components having different coefficients of thermal expansion which among other things run into one another. At the same time, under the predominantly high temperature fluctuations, large displacements of the individual components occur among one another, which are caused by different thermal expansions. Functional disturbances can occur in this case.

FIG. 3 shows a perspective view of an arrangement of pulse-modulated quick-acting valves 24′ to 24″″ in a valve head 26 of a fluid storage device which is configured as a single tank container 28, according to a first embodiment of the present invention. For reasons of clarity only the visible valves 24′ to 24′″ are provided with reference numbers. The valve head 26 is connected in a fluid-tight manner to the tank container 28. The valve head 26 is furthermore in fluid communication with a refuelling line. Due to the representation only three quick-acting valves 24′ to 24′″ can be identified in FIG. 3. The valve head 26 can, however comprise a plurality of, for example, four, five or six quick-acting valves. The respectively inlet sides of the quick-acting valves 24′ to 24′″ are in fluid communication with the tank container 28. The respective outlet sides of the quick-acting valves 24′ to 24′″ are in fluid communication with a branch integrated in the valve head 26. A compensating container 30 which is configured to absorb pressure waves is further connected to the outlet side or low-pressure side of the valve head 26. An outlet line (not shown) for supplying a fuel cell (not shown) with hydrogen is connected on the outlet side of the compensating container 30.

FIG. 4 shows a perspective sectional view of the arrangement shown in FIG. 3. Shown in schematic sectional view in this view are two of the quick-acting valves 24′ and 24″ which are arranged in the circumferential direction inside the valve head 26. As mentioned previously, four quick-acting valves 24′ to 24″″ are provided here but depending on the case of application, more or fewer valves can be selected. The quick-acting valves 24′ to 24″″ comprise nozzle components having respectively different nominal width for their respective operation in different pressure ranges with otherwise identical structure. The respective nominal widths are selected and matched to a fluctuation range of the pressure in the tank container 28 such that over this fluctuation range of the storage device pressure a total dispensed mass flow of hydrogen from the tank container 28 can be produced in a fluctuation range of varying mass flows of constant pressure as required. For this purpose, the individual quick-acting valves 24′ to 24″ are operated by complete opening, complete closing, and/or switching individual valves or valve combinations.

For example, one of the quick-acting valves has a nozzle component having a nominal width of 0.5 mm, wherein this quick-acting valve is then operated at a pressure of, for example, 700 to 15 bar by complete opening or switching or switching over. Another quick-acting valve can contain a nozzle component having a nominal width of approximately 1.5 mm, wherein this quick-acting valve is operated at an inlet pressure of 130 to 15 bar by complete opening or switching or switching over. At the lowest inlet pressure, that is at a pressure of less than 15 bar, all the quick-acting valves then open.

Consequently, the nominal width of the nozzle component and therefore also the cross-section of a quick-acting valve having the largest nominal width can be smaller than the total required cross-section for the maximum mass flow at 15 bar or less. The valve head 26 further contains a temperature sensor 32 for measuring the temperature of the valve head 26. Consequently, along with the inlet parameters of inlet pressure, required mass flow and required constant outlet pressure, the temperature inside the valve head 26 can further be included for determining which quick-acting valves are opened, closed or switched. A particularly precise operation is hereby made possible.

FIG. 5 shows a perspective sectional view of a pulse-modulated quick-acting valve 24. The valve 24 comprises a cylindrical housing 34 containing a coil body 36 which in turn surrounds a pressure pipe 38. The pressure pipe 38 encloses a core 40 in its interior on the high-pressure side HDS and a yoke part 42 on a low-pressure side NDS. Accommodated inside the pressure pipe 38 and between the core 40 and the yoke part 42 is an armature 44 which is movable in the axial direction of the pressure pipe 38. A first chamber 46 is formed between the upper side of the armature 44 and the core 40. This occupies a maximum volume as soon as the armature is located in the lowermost position (as shown in the Figure). A second chamber 48 is formed between the underside of the armature 44 and the yoke part 42. This occupies a maximum volume as soon as the armature 44 is moved into the opposite position.

At its upper end the yoke part 42 contains a seat in which a nozzle component 50 is inserted. This nozzle component 50 has a predetermined nominal width. The figure shows the fluid path from the high-pressure side HDS to the low-pressure side NDS by arrows. The fluid flows via the core 40 into the first chamber 46 and flows via two holes incorporated inside the armature 44 in the axial direction in the direction of the second chamber 48. From there the fluid flows via the nozzle component 50 into the yoke part 42 and from there to the low-pressure side NDS. The cooperation between the inlet pressure on the high-pressure side HDS, the pressure in the first chamber 46 and the resulting force on the armature 44 as well as the pressure in the second chamber 48 and the resulting force on the armature 44 substantially determines the position of the axially movable armature 44.

In this case, the nominal width of the nozzle component 50 plays an essential role. The smaller the nominal width, the smaller is the closing force and the closing tendency of the armature 44 since the pressure difference between the high-pressure side HDS and the low-pressure side NDS multiplied by the cross-sectional area of the nozzle becomes smaller. The quick-acting valve 24 shown in the figure is designed in such a manner that in the non-energised state of the coil body 36, the armature 44 is located in the valve closing position into which it is moved by the applied high pressure. In order to be able to axially displace the armature 44 against the high pressure and thereby move or switch it into the valve open position, the coil body 36 and the armature 44, together with the housing 34, the core 40 and the yoke part 42 are configured as an electromagnet. The electromagnetic valve arrangement is ultimately obtained from the cooperation of this electromagnet with the nozzle component 50 and a sealing element 52 which is provided on the yoke-side underside of the armature 44. When the coil body 36 is energised, an electromagnetic field is produced which exerts a force on the armature 44 in the direction of the valve open position (that is directed upwards in the figure). The coil body 36 and the armature 44 are designed in such a manner with respect to one another that when the coil body 36 is energised, the power is sufficient to displace the armature 44 into the valve open position. At the axial ends of the coil body 36 the magnetic field runs over the valve housing 34 towards the core 40 or towards the yoke part 42. By designing these parts 34, 40 and 42 of a magnetically conductive material, the magnetic field is intensified and focussed in the action on the armature 44. Since the armature 44 additionally at least partially embraces the yoke part 42, the magnetic flux is not interrupted at this point, which further intensifies its effect. As a result, the same valve 24 can be used over a wide pressure range without valves of different design being required.

In the case of quick-acting valves 24 using a nozzle component 50 having a larger nominal width compared with the previous example, a greater closing force and closing tendency will be produced at the same pressure difference between the high-pressure side HDS and the low-pressure side NDS. In this case, the electromagnetic force is frequently not sufficient to move the armature 44 into the valve open position. This has the advantage that in the event of an unintentional energising of the electromagnet (34, 36, 40, 42, 44) or in the event of a component failure, no uncontrollably large mass flow can occur. Only with a decreasing pressure on the high-pressure side HDS and a resulting reduced force difference on the armature 44, is the power of the electromagnetic valve arrangement sufficient to move the armature 44 into the valve open position.

By means of a suitable choice of the respective nominal widths of the different nozzle components 50 in the different quick-acting valves 24, pressure ranges are therefore defined on the high-pressure side within which the defined quick-acting valves can be operated. The operation here comprises the complete opening, complete closing and/or switching or switching over the fluid connection. For reliable sealing of the quick-acting valve 24 in the valve closed position, a sealing element 52 is attached to the underside of the armature 44 which presses against the opening on the nozzle component 50 on the side of the second chamber 48 and thereby seals in a fluid-tight manner.

FIG. 6 shows a functional diagram of the arrangement shown in FIG. 3 with a diagram D1 showing the switching intervals in relation to the time t and a diagram D2 showing the outlet pressure p in relation to the time t. The positions of the respective measurement recording are identified by arrows. The first diagram D1 shows the cycle of the switching of the first quick-acting valve 24′ by a switching or switching over.

The respective outlet side of the pulse-modulated quick-acting valve 24′ to 24″″ is connected via a low-pressure line 54 to a fuel cell (not shown). The respective inlet side of the pulse-modulated quick-acting valve 24′ to 24″″ is in turn connected via a refuelling line 56 to the tank container 28. The valve head 26 and the compensating container 30 are connected at the tank container 28. The quick-acting valves 24′ to 24″″ contained inside the valve head 26 are shown schematically. The dashed lines refer to the respective components in the schematic diagram. The quick-acting valves 24′ to 24″″ contain a respective nozzle component having different nominal width which becomes gradually smaller starting from the valve 24″″ towards the valve 24′.

Depending on the pressure prevailing in each case in the tank container 28 and the required mass flow, divided into pressure ranges, individual quick-acting valves 24′ to 24″″ can be operated by complete opening, complete closing and/or switching or switching over. At a maximum pressure, as described previously, only the quick-acting valve 24′ (having the smallest nominal width) can be operated for complete opening and/or switching over since only here is the power of the electromagnetic valve arrangement sufficient for moving the armature (not shown) into the valve open position. By implication, therefore the electromagnetic valve arrangements only need to be designed in such a manner that their power is sufficient to move the armature in at least its predetermined pressure ranges. Following on from this, the elements of the electromagnetic valve arrangement, i.e. the electromagnet and the armature (both not shown) are designed in such a manner that they have a small overall size and a low weight. Consequently, the individual quick-acting valves 24′ to 24″″ overall have a small overall size and a low weight and are additionally inexpensive.

For example, the pressure of the hydrogen supplied by the tank container 28 can lie in a pressure range between 700 bar and 500 bar. In order to reduce this pressure to a required outlet pressure of approximately 2.4 bar, the switching valve 24′ is switched with the switching cycle shown in the diagram D1. Here each switching cycle has a duration of 2.5 seconds, which corresponds to a frequency of 0.4 Hz. The pressure present on the outlet side is, shown in diagram D2. The curve profile of diagram D2 shows that on the outlet side a pressure in a range between 2.4 and 2.5 bar is present, fluctuating in a sawtooth manner. This sawtooth-like fluctuation lies within the tolerance range and could be further reduced, for example, by making changes to the compensating container 30. At a maximum inlet pressure of 700 bar and a required minimal mass flow of 0.008 g/sec, likewise only the valve 24′ having the smallest nominal width is switched, which is also the case at an average inlet pressure of 350 bar and a required minimal mass flow of 0.008 g/sec. On the other hand, at an average inlet pressure of 350 bar and a required maximum mass flow of 2,500 g/sec, the valve 24′ is ultimately permanently opened and the valve 24″ is switched. At a minimal inlet pressure of 15 bar and a required maximum mass flow of 2,500 g/sec, on the other hand, all four valves 24′ to 24″″ are permanently opened.

FIG. 7 shows a perspective view of an arrangement of pulse-modulated quick-acting valves in valve heads 26′ to 26″″ of a fluid storage device consisting of a plurality of interconnected tank containers 28′ to 28″″ according to a second embodiment of the present invention. In this example, the fluid storage device thus consists of four interconnected tank containers 28′ to 28″″ each having a single valve head 26′ to 26″″. Each valve head 26′ to 26″″ in turn comprises a single quick-acting valve (not shown). The outlet sides of the respective quick-acting valves are interconnected via a low-pressure line 54. This low-pressure line 54 is connected to the previously described compensating container 30 to absorb pressure waves. This compensating container 30 is in turn connected via a further line to a fuel cell (not shown) but can also be configured as a dead volume in the tank line or fuel cell itself.

The arrangement is refuelled via a refuelling line 56. The refuelling line 56 extends further in each case between the high-pressure sides of the individual valve heads 26′ to 26″″ and is there opened towards the interior thereof so that the entire refuelling line 56 is overall in fluid communication with all the tank containers 28′ to 28″″. Consequently, a pressure equalisation between the individual tank containers 28′ to 28″″ is always produced via this refuelling line 56.

The quick-acting valves disposed in the individual valve heads 26′ to 26″″ are operated individually as a function of the inlet pressure, the required mass flow and the predefined constant outlet pressure, as has already been described in FIG. 6.

An advantage of this arrangement according to the second embodiment compared with that according to the first embodiment is that the entire fluid storage device, which is here formed by the four tank containers 28′ to 28″″ can be designed more flexibly. Subject to the requirement of supplying the same fluid volume, the four tank containers 28′ to 28″″ each containing a quarter of the fluid volume compared to the tank container according to the first embodiment can be accommodated more flexibly, in a more space-saving and compact manner in the respective receiving space of a vehicle due to their consequently smaller overall size.

FIG. 8 shows a perspective sectional view of one of the tank containers 28″″ shown in FIG. 7, its valve head 26″″, its refuelling line 56 and the low-pressure line 54 leading to the compensating container (not shown). As described previously, the refuelling line 56 runs between the individual valve heads, wherein these contain a respective hole for the passage which has an opening towards to the interior of the tank container 28″″. In this sectional view the (single) quick-acting valve 24″″ disposed in the valve head 26″″ is shown schematically. The outlet sides of the respective quick-acting valves are interconnected via the low-pressure line 54. A particular advantage of this arrangement is that the respective quick-acting valves have a very small overall size with the result that in turn the overall size of each valve head can advantageously be further reduced. An exemplary valve head can have a length of 4.5 cm (measured from the upper side of the tank container) and a diameter of 4.5 cm.

FIG. 9 shows a functional diagram of the arrangement shown in FIG. 7, the quick-acting valves 24′ to 24″″ whereof are switched depending on the storage device pressure as has already been explained with a view to FIG. 6. The principle of the switching according to the invention is therefore fundamentally independent of whether the fluid storage device comprises one or several tank containers (usually tank containers 28′ to 28″″). The crucial thing is that all the applied pressures can be regulated as required by a suitable selection and arrangement of the valves 24′ to 24″″.

FIG. 10 shows a diagram of a curve profile of the outlet pressure p in relation to the time t for the arrangement shown in FIG. 7. Here it can be identified that the reduced outlet pressure fluctuates in a range between 2.4 and 2.5 bar with a sawtooth profile. This fluctuation in a range of 0.1 bar is small compared with the prior art and can be still further reduced by a verification of the compensating container.

1. Arrangement of pulse-modulated quick-acting valves on a fluid storage device, wherein the valves have different nominal widths for operation thereof in different pressure ranges with otherwise identical structure and the number of the valves and the respective nominal widths thereof is selected and matched to a fluctuation range of the pressure in the storage device such that over this fluctuation range of the storage device pressure, by complete opening, complete closing and/or switching individual valves or valve combinations, a total dispensed mass flow of the fluid from the storage device in a fluctuation range of varying mass flows of constant pressure as required can be produced.

2. The arrangement according to claim 1, in which the fluid storage device is configured as a single tank container which has a valve head comprising a group of quick-acting valves.

3. The arrangement according to claim 1, in which the fluid storage device comprises of a plurality of interconnected tank containers which have a respective valve head comprising a single quick-acting valve.

4. Apparatus comprising at least two quick-acting valves for connection to a fluid storage device, wherein the at least two valves can be triggered by means of pulse modulation, wherein the at least two valves have respectively different nominal widths and wherein the respective nominal widths cover a fluctuation range of the pressure in the storage device, wherein in the fluctuation range of the pressure a respectively constant pressure at a required variable mass flow can be set by triggering at least one of the at least two valves.

5. The apparatus according to claim 4, in which the fluid storage device is configured as a single tank container which has a valve head comprising a group of quick-acting valves.

6. The apparatus according to claim 4, in which the fluid storage device consists of a plurality of interconnected tank containers which have a respective valve head comprising a single quick-acting valve.

7. A tank system comprising a fluid storage device for receiving and supplying a fluid, and at least two quick-acting valves for removing the fluid from the storage device, wherein the at least two valves can be triggered by means of pulse modulation, wherein the at least two valves have different nominal widths and wherein the respective nominal widths cover a fluctuation range of the pressure in the storage device, wherein in the fluctuation range of the pressure a respectively constant pressure can be set by triggering at least one of the at least two valves at required variable mass flow.

8. The tank system according to claim 7, in which the quick-acting valves comprise a respective pressure pipe having an armature made of a magnetically conductive material mounted so that it can be moved therein towards a nozzle component, wherein the pressure pipe is surrounded by a cylindrical coil body, whose axial ends extend beyond a movement range of the armature in the pipe and are connected in a magnetically conductive manner to a core and a yoke part of the respective valve, which fix the movement range of the armature in the pressure pipe and the armature embraces the yoke part at least partially.

9. The tank system according to claim 7, in which the fluid storage device is configured as a single tank container having a valve head connected thereto, which comprises a group of quick-acting valves.

10. The tank system according to claim 7, in which the fluid storage device consists of a plurality of interconnected tank containers having a valve head connected thereto in each case, which comprises a single quick-acting valve.

11. The tank system according to claim 9, in which a low-pressure side of the at least one valve head is connected to a compensating container to absorb pressure waves.

12. The tank system according to claim 9, in which the at least one valve head comprises a temperature sensor for measuring the temperature of the fluid in the tank container.

13. The tank system according to claim 9, in which the high-pressure side of the at least one valve head can be connected to at least one refuelling line.

14. The tank system according to claim 7, in which quick-acting valves have a nozzle component having respectively different nominal width.

15. The tank system according to claim 7, in which the nominal width of the individual quick-acting valves lies in a range of approximately 0.2 mm to 2.5 mm.

16. The tank system according to claim 7, in which the fluctuation range of the storage device pressure lies between 10 bar and 900 bar and the fluctuation range of the required mass flow lies between 0.005 g/sec and 2,500 g/sec at a constant output pressure of less than 4 bar.

17. A method for supplying a required mass flow of a fluid at constant pressure, wherein the fluid can be removed from a variable-pressure fluid storage device, comprising the steps:
determining the current pressure in the storage device and determining the required mass flow;
pulse-modulated opening, closing and/or switching of quick-acting valves of different nominal width on the storage device depending on the determined pressure so that the required mass flow of constant pressure is produced;
repeating the preceding steps in the course of removing the fluid from the storage device.

18. The method according to claim 17, in which in the event of an incorrect energisation of at least one of the quick-acting valves, a predetermined selection of valves dependent on the determined pressure is opened so that an actually delivered mass flow actually lies below the incorrectly required mass flow.

19. Use of a tank system according to claim 7 for supplying a fuel gas, in particular hydrogen to a fuel cell, in particular to a fuel cell in a vehicle.
